(19) United States
(12) Patent Application Publication
(10) Pub. No.: US 2006/0120497 A1
(43) Pub. Date: Jun. 8, 2006

(54) Method for resampling at transmission and reception of a digital signal with digital band translation

(76) Inventors: Jorge Vicente Blasco Claret, Valencia (ES); Juan Carlos Riveiro Insua, Valencia (ES); Salvador Iranzo Molinero, Valencia (ES); Aitor Garcia San Jose, Valencia (ES)

Correspondence Address: STEFAN J. KLAUBER;KLAUBER & JACKSON, 4TH FLOOR, 411 HACKENSACK AVE., HACKENSACK, NJ, 07601, US

(21) Appl. No.: 11/288,957

(22) Filed: Nov. 29, 2005

Related U.S. Application Data
(63) Continuation of application No. PCT/ES04/00224, filed on May 31, 2004.

(30) Foreign Application Priority Data
May 30, 2003 (ES) P200301288

(51) Int. Cl. H04L 7/00

(52) U.S. Cl. 375/355

(57) ABSTRACT

The invention relates to a method for resampling at transmission and reception of a digital signal with digital band translation. According to the invention, a resampling (25) is performed upon reception of a bandpass signal, whereby the signal is translated (4) to baseband with a configurable frequency and the resulting baseband signal is introduced into a decimator (5). In addition, a resampling (26) is performed upon transmission, whereby the baseband signal is interpolated (10) and, subsequently, translated to bandpass (20) with a configurable frequency. The inventive method can be used to correct the frequency error introduced by digital/analogue (11) and analogue/digital (1) converters. Moreover, the set formed by the band translation and the aforementioned resampling can be used to simplify the complexity of the interpolation filters used to generate new samples of the digital signal.

### RELATED APPLICATIONS

The present application is a Continuation of co-pending PCT Application No. PCT/ES2004/000224, filed May 31, 2004, which in turn, claims priority from Spanish Application Serial No. P200301288, filed May 30, 2003. Applicants claim the benefits of 35 U.S.C. § 120 as to the PCT application and priority under 35 U.S.C. § 119 as to said Spanish application, and the entire disclosures of both applications are incorporated herein by reference in their entireties.

### OBJECT OF THE INVENTION

As stated in the title of this descriptive specification, the present invention relates to a method for resampling at transmission and reception of a digital signal with digital band translation, permitting correction of the frequency error introduced frequency error introduced by digital-analogue and analogue-digital converters used in telecommunications systems.

The method of the invention simplifies the electronics needed for performing resampling in bandpass signals.

### BACKGROUND OF THE INVENTION

In the majority of telecommunications systems, the transmitted signal is resampled at reception by an analogue-digital converter using a time-constant sampling frequency. As this sampling frequency is not exactly equal to the transmission frequency, it is necessary to interpolate the received signal in order to obtain the samples that would be received if the two frequencies were to be equal, and thereby be able to correctly demodulate the previously transmitted data.

Gardner in “Interpolation in Digital Modems: Part I: Fundamentals. IEEE Transactions on Communications, Vol 41, No 6, Jun. 1993”, presents the fundamentals of time synchronisation by means of interpolation techniques, while in “Interpolation in Digital Modems: Part II: Implementation and Performance. IEEE Transactions on Communications, Vol 41, No 6, Jun. 1993”, he conducts a study on the implementation of interpolators by means of digital filters.

The interpolation structure described in the stated references display various drawbacks. Among the main ones can be highlighted the excessive complexity and the enormous size of the interpolation filters needed for their application in the resampling of bandpass signals. Another of the drawbacks consists of the fact that the working frequency of the filters is so high that their implementation is very costly.

The invention forming the object of the patent proposes a variation on the interpolation structure that facilitates its implementation reducing the complexity of the filters and also their working frequency. Moreover, the resampling is performed not just at reception but also at transmission.

It can be stated that during the course of the description the acronym CORDIC (Coordinate Rotation Digital Computer) is used, which refers to an algorithm for the calculation of mathematical functions optimised for their physical implementation. This algorithm is known in the state of the art and its explanation has not been included in this pro forma. The initials DAC and ADC are also used to refer to digital-analogue and analogue-digital converters, while the initials OFDM refers to modulation by orthogonal frequency division multiplexing.

### DESCRIPTION OF THE INVENTION

In order to achieve the objectives and avoid the drawbacks stated in the above paragraphs, the invention consists of a method for resampling at transmission and reception of a digital signal with digital band translation, which selectively comprises a processing at transmission, at reception or a combination of both.

At reception, the processing comprises sampling of the signal at reception by means of an analogue-digital converter (ADC), a band translation of the signal and a processing of the signal in the time domain. Owing to the fact that the majority of communication channels and bandpass channels, the information is transmitted in bandpass due to which, at reception following the analogue-digital conversion (ADC), a bandpass translation is performed on the digital signal. The invention provides that upon reception an adjustment is performed in the band translation frequency of the digital signal in the conversion process of the signal to baseband, and following said conversion the signal is decimated in order to reduce the sampling frequency and eliminate replicas. Following decimation of the baseband signal, the signal is resampled to obtain the desired samples.

The processing of the signal that is performed at reception following resampling is carried out continuously and the blocks located behind the resampler have to be capable of absorbing the variations in output frequency of the signal from the resampler, for which an overdimensioning of the hardware is carried out.

In the processing at transmission, the baseband signal is resampled. Following the resampling, the signal is interpolated to increase the sampling frequency. Afterwards, the signal is translated in frequency to obtain a bandpass signal and feed it to the digital-analogue converter (DAC) where the signal is converted into an analogue signal for its transmission. In the translation process the invention provides for carrying out the adjustment of the band translation frequency of the digital signal.

As the number of samples exiting from the resampler at transmission is variable in time, following the resampler a memory has been introduced which is responsible for absorbing all the samples of the resampling block and feeding them to the interpolation block with a fixed cadence. In other words, the speed with which the samples are introduced in the memory is variable and the reading speed of the memory is fixed.

In order for the operation of the memory at transmission to be robust, the reading and writing indexes will return to their initial values whenever it is not transmitting or it is transmitting zeros.

Moreover, whenever the writing speed is higher than the reading speed, the memory will start to read immediately after the first write.

When the reading speed is higher than the writing speed, a defined number of samples must be written before starting to read the memory, said number of samples being calculated on the basis of the applied resampling factor and on the duration of the transmission.

The calculation of the dimensions of the memory is done taking as reference the maximum transmission time and the maximum resampling factor, in such a way that no sample that is introduced into that memory is lost.

On the other hand, in order top perform the bandpass translations to baseband at reception and from baseband to bandpass at transmission, it is necessary to calculate at least one sine and one cosine, for which a CORDIC is used.

In an embodiment of the invention for reducing the complexity of the resampler, both at transmission and at reception, the signal is interpolated prior to being applied to the input of the resampler by a whole value, while at its output the samples are decimated by the same factor.

Standing out among the most important advantages of this invention is the simplification of the structure of filters necessary for resampling a bandpass signal in addition to a reduction in the working frequency of the filters in order to facilitate their implementation, the possibility of performing the resampling at transmission and not just at reception, and the fact that, thanks to the possibility of using the CORDIC algorithm with the inventive method, an implementation of the frequency translation is achieved permitting great flexibility when it comes to locating the signal in the band of interest.

Below, in order to facilitate a better understanding on this specification and forming an integral part thereof, some figures are attached in which, by way of illustration and not to be regarded as limiting, the object of the invention has been represented

### BRIEF DESCRIPTION OF THE FIGURES

FIG. 1. Schematically represents a block diagram carrying out the resampling at reception.

FIG. 2. Schematically represents a block diagram carrying out the resampling at transmission.

FIG. 3. Represents the memory located after the resampler at transmission with the reading and writing indexes.

FIG. 4. Represents an implementation of the resampling block with interpolation and decimation.

### DESCRIPTION OF AN EXAMPLE OF EMBODIMENT OF THE INVENTION

A description is made forthwith of an example of the invention, making reference to the numbering adopted in the figures.

In the majority of communications systems the signal is transmitted in bandpass, in other words occupying a range of frequencies not including zero frequency. In order to facilitate the implementation of the electronic needed for transmitting and receiving the signal, the latter is internally processed in baseband, in other words in a range of frequencies that includes zero, and is then translated to bandpass at transmission. At reception the reverse process is performed.

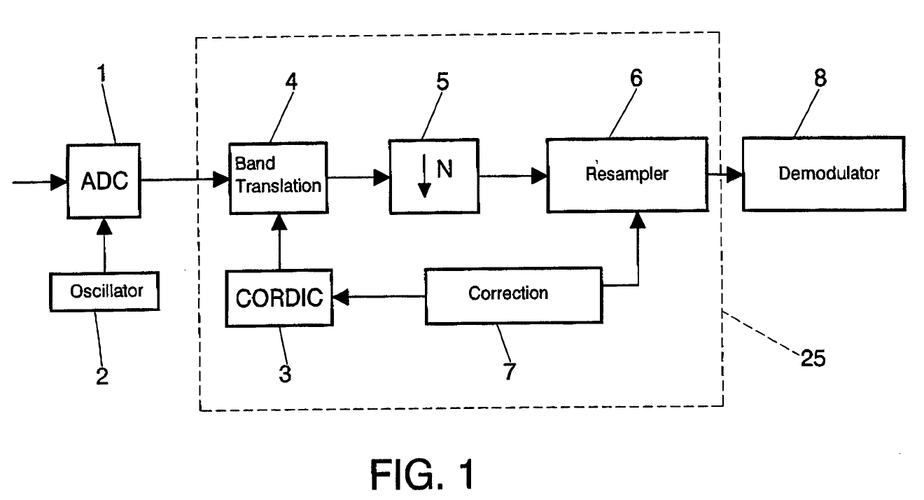

Moreover, in digital communications systems there is always an error between the sampling frequency of the DAC and ADC converters used in transmission and reception respectively. If that error is greater than that which can be permitted by the telecommunication system to which it is being applied then a correction needs to be carried out, and one of the techniques that can be used is resampling, which consists of using a sequence of samples of some defined instants of time in order to obtain the samples corresponding to other instants of time. FIG. 1 shows the resampling process at reception in this example of embodiment as the set of blocks (25).

This resampling is normally done directly with the bandpass signal after sampling the reception signal by means of an ADC (1), in other words, using a sampling block (6) directly, which means that the electronics used has to function at the same frequency as that generated by the oscillator (2) of the ADC converter, and the resampling filters have to have sufficient bandwidth in order not to distort the signal. Instead of directly using a resampling block (6), the inventive method uses a set of blocks (25) for achieving the resampling of the signal, with the advantages stated above. At transmission, the process is similar except that the resampling block (16) conventionally used is replaced by the set of blocks (26) in order to carry out the resampling following the inventive method.

In the case of bandpass signals, the system is being overdimensioned because it works at very much higher frequencies than those which would be used if working in baseband. Therefore, at reception it is better to perform the baseband translation by means of a band translation block (4) directly after the ADC (1). In this example of embodiment, the block (4) corresponds to two multipliers, one of the signal with sine and the other with cosine. As will be described further below, at transmission a band translation block (20) is also used, this being done in a similar way though adding on a summer. This frequency translation is not fixed since it depends on the error introduced into the converters, due to which it has to be adjusted in line with the error being corrected. Following the frequency translation, the invention carries out a decimation (5) of the signal by a whole factor, N, in order to reduce the sampling frequency at the output from the decimator and eliminate the replicas appearing with the band translation. After that, resampling of the signal is performed. The resampling block (6) is known in the state of the art and can be used in different ways as described in part II of the article referenced in the background. By working at a lower frequency and which also depends on the decimation factor, N, the design and the embodiment of the resampling filters is simpler. FIG. 1 also shows a block (7) which is responsible for determining the frequency correction to apply, and which as has been explained affects the baseband translation, by means of variation of the baseband translation frequency via a CORDIC (3), and the resampling block (6) which as has been said is known in the state of the art and which obtains digital samples at its output as if the analogue signal equivalent to the digital signal at its input were to have been sampled with a frequency different from that used for sampling the signal at its input.

The frequency of the samples at the output from the resampling block (6) is different from the frequency at the input by the applied correction (7), and the processing blocks of the signal, among which the first of them is a demodulator (8) located after the resampler, have to be capable of absorbing this variation. This is especially important if the processing can never be stopped as in the case of a synchronisation block, since the frequency of the samples can be slightly greater than the frequency of the clock used by those synchronisation blocks, and this compels an overdimensio9onmg of them. In other cases, the processing is not continuous, as in DFT (Discrete Fourier Transform) used in the demodulation of an OFDM signal, and the variation is absorbed with no major consequences. If the samples frequency at the output from the resampler is less than at its input then stopping the demodulator (8) does not imply any problem when there are no samples available at its input.

The resampling of the signal can also be done at transmission in such a way that the receiver receives the same samples as it would obtain in the event of it itself performing the resampling. The resampling can also be performed simultaneously at transmission and reception in such a way that the error introduced by the converters is corrected between the two processes.

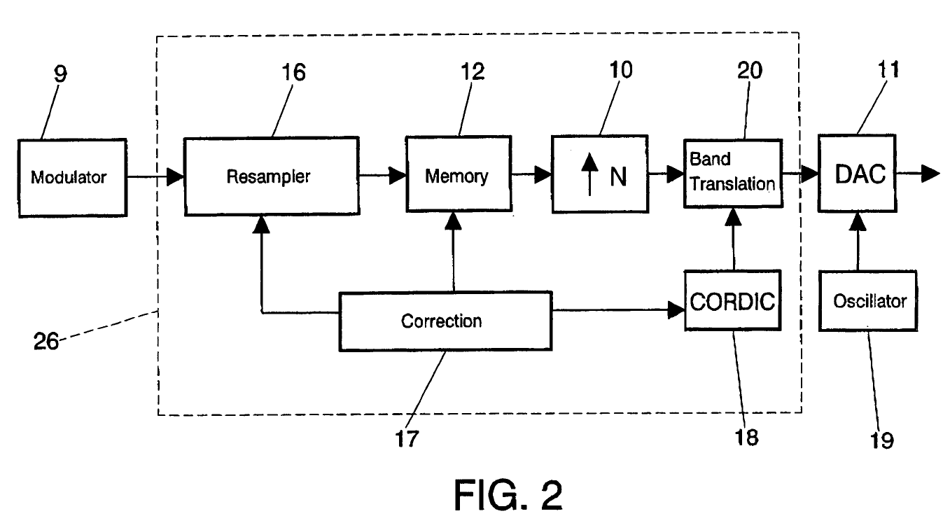

The resampling at transmission can be performed according to FIG. 2, in which the samples to transmit come from a modulator (9) and pass to the resampling block (16). The signal is then interpolated (10) by a whole factor N in order to increase the sampling frequency and the signal is translated to bandpass thanks to the translation block (20), already mentioned earlier. Finally, the samples of the bandpass filter pass to a DAC converter (11). A transmission correction block (17) determines the correction to apply in the resampler and in the band translation, in a way similar to that done in reception. Also, this figure shows the blocks (19) representing the oscillator which provides the frequency for the DAC and the block (18) representing a CORDIC circuit. In another embodiment of the invention, if the transmission and reception are performed at different moments, in other words, if a time division is made for using the channel, certain blocks of the system can be reused, such as for example using the same CORDIC block for (3) and (8), one translation block for (4) and (20), one resampling block for (6) and (16), one correction block for (7) and (17), and one oscillator (190) and (2); with the functioning of the block being adjusted to the signal transmission and reception periods

FIG. 2 also shows a memory (12) in which the resampler writes its output samples and from where the interpolator reads them. Both operations are performed with circular pointers (13) and (14), in other words, when the last position of the memory is reached the first is then continued with. The function of this memory is to absorb the difference in speed between the output of samples from the resampler and the input to the interpolator.

In the majority of communication systems there are pauses in the transmission since the channel has to be periodically resynchronised, estimated, etc., These pauses can be used for emptying the content of the memory and reinitiating the values of the pointers. Once the memory has been emptied and until it starts to function, zeros can be transmitted.

In resampling at transmission, as occurred with reception, there are two cases that can occur depending on the sign of the correction to make. Sometimes the sampling frequency at reception will less than that of transmission which means that the resampling procedure at transmission has to generate more samples than those presented at the input. In that case the speed of writing in the memory will be greater than that of reading and it will therefore be possible to read immediately after the first write.

In other cases, the sampling frequency at reception is greater than that of transmission which means that the resampling procedure at transmission writes the samples in the memory slower than they are read, in which case it waits for the reading pointer (14) to reach a certain position before starting to read. This value is calculated by the corrector block (17) starting from the applied correction and the duration of the transmission. In another less optimum embodiment the memory can wait to be filled up before starting to read.

In both cases the block (17) is the one which determines the functioning of the memory depending on the correction to be made, as shown in FIG. 2.

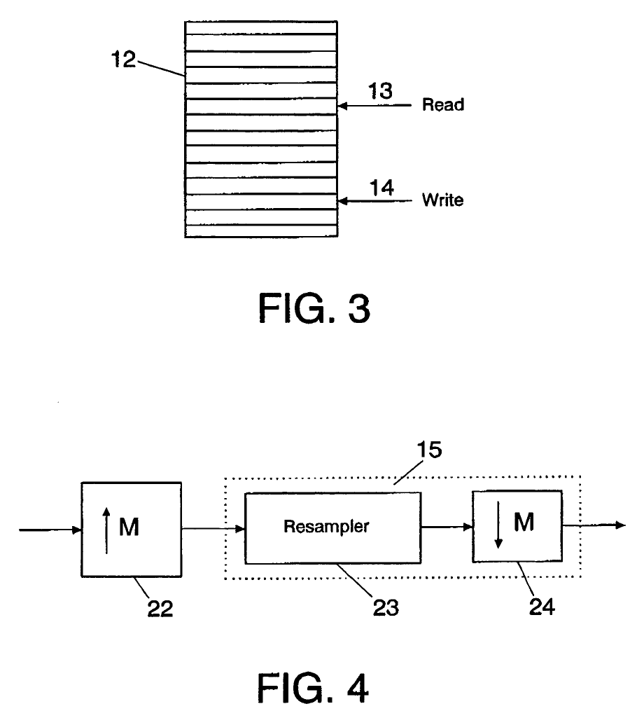

FIG. 3 shows a representation of the memory and its reading and writing pointers. In order for the reading point (13) not to get ahead of the writing pointer (14) under any circumstances, the size of the memory has to be calculated taking into account the maximum duration of a transmission and the maximum correction applied.

For band translation by means of the translation block (4) or (20), a sine and a cosine of a specific frequency need to be generated. Given that the procedure performs adjustments in this translation frequency, it is necessary to use an efficient algorithm for calculating the sine and the cosine of variable angles., since the adjustment of the frequency is done by varying the increment in the angle to be apply in each sample. For this, a CORDIC algorithm is used for calculating the sine and the cosine of any angle. In order to carry out the frequency translation the samples of the signal are multiplied (4) or (20) by the sine and the cosine of an angle. That angle is increased by modulus 360 degrees in each sample, and it is by means of the variation of that increment in angle made by the corrector block (7) or (17) that the adjustment in the translation frequency is carried out.

The resampling filters, at both transmission and reception, have to have sufficient bandwidth in order not to distort the signal. Depending on the bandwidth of the signal and on the sampling frequency it can occur that the implementation of these filters becomes overly complex in terms of the number of operations and even that it is not possible to obtain a filter that complies with the specifications. Moreover, in the majority of communication systems it is necessary for the signal not to vary during the transmission of a symbol, this being very important in systems which use OFDM modulation. In the embodiment of the resampling filters the response of the filter varies slightly in each sample due to the actual interpolation, this variation being greater for frequencies close to the rejection band of the filter, and this could affect the signal at those frequencies. As can be seen in FIG. 4 and from everything that has been described above, it could be a better option to carry out at both transmission and reception to perform an interpolation by a fixed factor M (22) before the resampling (3) and decimate by M (24) afterwards. The sampler blocks (6) and (16) can be replaced by the set of interpolator )22), resampler (23) and decimator (24) shown in this figure. In this way, the maximum digital frequency of the signal will be divided by M and the specifications of the resampling filter will be simpler to produce, though it has to function at a frequency M times greater. One of the advantages of this implementation is that decimation by M after the resampling consists solely of taking one out of every M samples since there is no replica of the signal to filter, in other words, it does not imply any additional calculation. Moreover, there is no need to calculate the samples that are eliminated, which means that the implementation of the resampling block (6), (16) or (23) can be simplified, as shown in FIG. 4 by means of the block (15) which groups together the resampler and the decimator. By simplifying the resampling filter, a more optimum solution can be obtained in terms of the number of operations to perform by means of using this structure with interpolation and resampling than in the case of using a resampling structure directly.

1. METHOD FOR RESAMPLING AT TRANSMISSION AND RECEPTION OF A DIGITAL SIGNAL WITH DIGITAL BAND TRANSLATION, which comprises at transmission a processing of the signal in the time domain, a frequency translation and a conversion of a digital signal into an analogue signal by means of a digital-analogue converter (DAC), and at reception the sampling of the signal by means of an analogue-digital converter (ADC), a band translation of the signal and a processing of the signal in the time domain; characterised in that a processing of the signal is selectively performed at transmission in which:
the baseband signal is resampled in order to obtain the desired samples;
the output samples from the resampler are introduced into a memory in which the writing speed is variable and the reading speed is fixed;
the signal is interpolated in order to increase the sampling frequency; and
an adjustment is performed to the band translation frequency of the digital signal;
or a processing of the signal is performed at reception in which
an adjustment is performed to the band translation frequency of the digital signal;
the signal is decimated in order to reduce the sampling frequency and eliminate replicas;
the baseband signal is resampled in order to obtain the desired samples; and
the variations in the output frequency of the samples from the resampler are absorbed by means of overdimensioning of the hardware in the receiver in a continues way;
or a combination of both processings.

2. METHOD FOR RESAMPLING AT TRANSMISSION AND RECEPTION OF A DIGITAL SIGNAL WITH DIGITAL BAND TRANSLATION, according to claim 1, characterised in that the writing and reading indexes of the memory are selectively reinitiated when not transmitting or when transmitting a burst of zeros.

3. METHOD FOR RESAMPLING AT TRANSMISSION AND RECEPTION OF A DIGITAL SIGNAL WITH DIGITAL BAND TRANSLATION, according to claim 1, characterised in that at transmission, following the first writing in the memory, reading is immediately started when the writing speed is greater than the reading speed.

4. METHOD FOR RESAMPLING AT TRANSMISSION AND RECEPTION OF A DIGITAL SIGNAL WITH DIGITAL BAND TRANSLATION, according to claim 1, characterised in that at transmission a certain number of samples are written in the memory before starting to read them when the writing speed is less than the reading speed, said number of samples being calculated from the applied resampling factor and the duration of the transmission.

5. METHOD FOR RESAMPLING AT TRANSMISSION AND RECEPTION OF A DIGITAL SIGNAL WITH DIGITAL BAND TRANSLATION, according to claim 1, characterised in that the size of the memory is calculated from the maximum transmission time and the maximum resampling factor.

6. METHOD FOR RESAMPLING AT TRANSMISSION AND RECEPTION OF A DIGITAL SIGNAL WITH DIGITAL BAND TRANSLATION, according to claim 1, in which in order to perform the translation in digital band it is necessary calculate at least one sine and one cosine; and said method is characterised in that said calculation is performed by means of CORDIC (Coordinate Rotation Digital Computer).

7. METHOD FOR RESAMPLING AT TRANSMISSION AND RECEPTION OF A DIGITAL SIGNAL WITH DIGITAL BAND TRANSLATION, according to claim 1, characterised in that an interpolation of the signal is performed by a whole value set by design, M, prior to the resampler, at the output of which the signal is decimated by the same factor.
